(19) United States
(12) Patent Application Publication
(10) Pub. No.: US 2009/0096778 A1
(43) Pub. Date: Apr. 16, 2009

(54) METHOD AND APPARATUS OF DETECTING IMAGE-STICKING OF DISPLAY DEVICE

(75) Inventors: Jung-Chih Su, Kaohsiung County (TW); Cheng-Han Kuo, Taipei County (TW)

Correspondence Address: J C PATENTS, INC., 4 VENTURE, SUITE 250, IRVINE, CA, 92618, US

(73) Assignees: TAIWAN TFT LCD ASSOCIATION, Hsinchu (TW); CHUNGHWA PICTURE TUBES, LTD., Taipei (TW); AU OPTRONICS CORPORATION, Hsinchu (TW); HANNSTAR DISPLAY CORPORATION, Tao-Yuan Hsien (TW); CHI MEI OPTOELECTRONICS CORPORATION, Tainan County (TW); INDUSTRIAL TECHNOLOGY RESEARCH INSTITUTE, Hsinchu (TW); TPO DISPLAYS CORP., Miao-Li County (TW)

(21) Appl. No.: 11/954,070

(22) Filed: Dec. 11, 2007

(30) Foreign Application Priority Data
Oct. 12, 2007 (TW) 96138175

(51) Int. Cl. G09G 5/00

(52) U.S. Cl. 345/214

(57) ABSTRACT

A method of measuring image-sticking of a display device based on a vision model is described. A display device is provided, and a test frame is displayed on the display device. The test frame has a pattern formed by a maximum gray level and a minimum gray level. After burning-in the test frame for a period of time, a gray frame at a medium gray level is displayed on the display device. The test frame, including portions of extreme black and extreme white, leaves image-sticking on the gray pattern at a medium gray level at the same time. Next, an image capture device is used to capture the image-sticking on the display device after burn-in. Finally, a vision model is employed to simulate the human visual perception on the image-sticking and to grade the image-sticking according to the human eye sensitivity for viewing the image-sticking on the display device.

### CROSS-REFERENCE TO RELATED APPLICATION

This application claims the priority benefit of Taiwan application serial no. 96138175, filed on Oct. 12, 2007. The entirety of the above-mentioned patent application is hereby incorporated by reference herein and made a part of this specification.

### BACKGROUND OF THE INVENTION

1. Field of the Invention

The present invention relates to a method and an apparatus of detecting image-sticking of a display device, and more particularly to a method and an apparatus for accurately grading image-sticking of a display device.

2. Description of Related Art

Image-sticking defect of a display device refers that an image or outline of a former static frame appears in a subsequent frame. That is, after the display device displays a static frame for a long period of time, when the next frame is displayed, an image or outline of the former static frame may be left on this frame. If the image-sticking defect of a display device is severe, it may influence the display quality of the display device, and thus, it has become an important task how to inspect and rank the level of the image-sticking for the display device.

In the conventional art, the image-sticking defect is detected through measuring electronic signals, for example, it is determined whether there is a significant image-sticking defect or not through measuring the change of voltage, current, or capacitance of a driving circuit. In addition, it may be further determined through measuring optical signals, for example, a luminance meter may be used to measure the change of the luminance on the frame of the display device, so as to inspect the image-sticking defect.

In U.S. Pat. No. 6,791,520, the method for measuring an image-sticking defect includes the following steps. Firstly, the display device is switched to a frame of extremely black or extremely white; next, a luminance meter is used to measure luminance at 13 point positions; then, an average luminance for the 13 point positions is calculated; and finally, the image-sticking degree is quantified according to the variation of the average value. In this method, merely the luminance changes at the specific point positions are considered. Actually, the positions where the image-sticking defect occurs are not fixed, such that the measurement performed at specific positions in the above method is quite meaningless, and on the contrary, the method of calculating the average value influences the effect of the whole image-sticking defect.

Furthermore, in U.S. Pat. No. 6,590,411, it determines whether the image-sticking defect exists or not by means of measuring capacitances in a driving circuit and calculating a capacitance difference to serve as the reference. However, this method cannot truly reflect the human visual perception for the image-sticking defect.

To sum up, since the image-sticking of the display device is not merely a simple change of physical quantity, but further involves ergonomic engineering, i.e., the actual human visual perception for the image-sticking defect. Therefore, through simply measuring the change of the physical quality by using instruments, it cannot truly reflect the human visual perception for the image-sticking defect.

### SUMMARY OF THE INVENTION

The present invention is directed to provide a method and apparatus of detecting image-sticking of a display device, which is capable of simulating the human visual perception level and thus determining the level of the image-sticking of the display device.

The present invention provides a method of detecting image-sticking of a display device based on a vision model, which includes the following steps. Firstly, a display device is provided, and a test frame is displayed on the display device for burning in. After burning in the test frame for a period of time, a gray frame at a medium gray level is displayed on the display device, in which the gray level of the gray frame is between a minimum gray level and a maximum gray level, and the gray level of the test frame is different from that of the gray frame at the medium gray level. Then, an image capture device is used to capture an image when the display device displays the gray frame at the medium gray level. The image signal captured by the image capture device is quantified and the human visual perception to the image-sticking is simulated based on a vision model. Finally, the severity degree for the image-sticking is graded and classified.

The present invention further provides an apparatus of detecting image-sticking of a display device, which includes a pattern generator, an image capture device, a vision model and a controller. The pattern generator is electrically connected to a display device, and a pattern generated by the pattern generator may be input to the display device, such that the display device displays a test frame. The image capture device is disposed in front of the display device for capturing the images displayed on the display device. The vision model is used to calculate the sensitivity of human eyes towards such stimulation according to the image signals captured by the image capture device, and convert the sensitivity into the feeling of human eyes when viewing the image-sticking. The controller is electrically connected to the vision model, the pattern generator and the image capture device, for receiving simulation results from the vision model, controlling the pattern generator and controlling the image capture device.

After the testing steps, the present invention utilizes an image capture device to capture the images on the display device and quantifies the images to simulate the feelings of human eyes when viewing the image-sticking, and then, the severity degree for the image-sticking defect is graded, so as to define the levels capable of meeting the human eyes' actual perceptual level for the image-sticking defect.

In order to make the aforementioned and other objects, features and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an apparatus of detecting image-sticking of a display device according to an embodiment of the present invention.

FIGS. 2A to 2D are schematic views of detecting frames according to several embodiments of the present invention.

FIG. 3 is a schematic view of a training mode and a detecting mode according to an embodiment of the present invention.

FIG. 4 is a flow chart a detecting method according to an embodiment of the present invention.

FIGS. 5A to 5D are schematic views of four image-sticking levels.

### DESCRIPTION OF EMBODIMENTS

Generally speaking, determining the image-sticking level of a display device is an important index for determining whether the display device products are qualified or not to ship. Therefore, before the shipment of the display device, burn-in and image-sticking detection processes are required. The method of detecting image-sticking of a display device provided in the present invention is capable of determining the image-sticking levels by means of simulating human visual perception, which may be applied to various display devices. The present invention is described through the following embodiments, such that those ordinarily skilled in the art can implement the present invention accordingly, but the embodiments are not used to restrict the scope of the present invention.

FIG. 1 is a schematic view of an apparatus of detecting image-sticking defect of a display device according to an embodiment of the present invention. Referring to FIG. 1, the apparatus of detecting image-sticking defect of the display device comprises a pattern generator 102, an image capture device 104, a vision model 106 and a controller 108.

The pattern generator 102 is electrically connected to the display device 110 under test, and a pattern generated by the pattern generator 102 is output to the display device 110, such that the display device 110 displays a test frame 112 for burning in. Here, the display device may be a liquid crystal display or a plasma display panel.

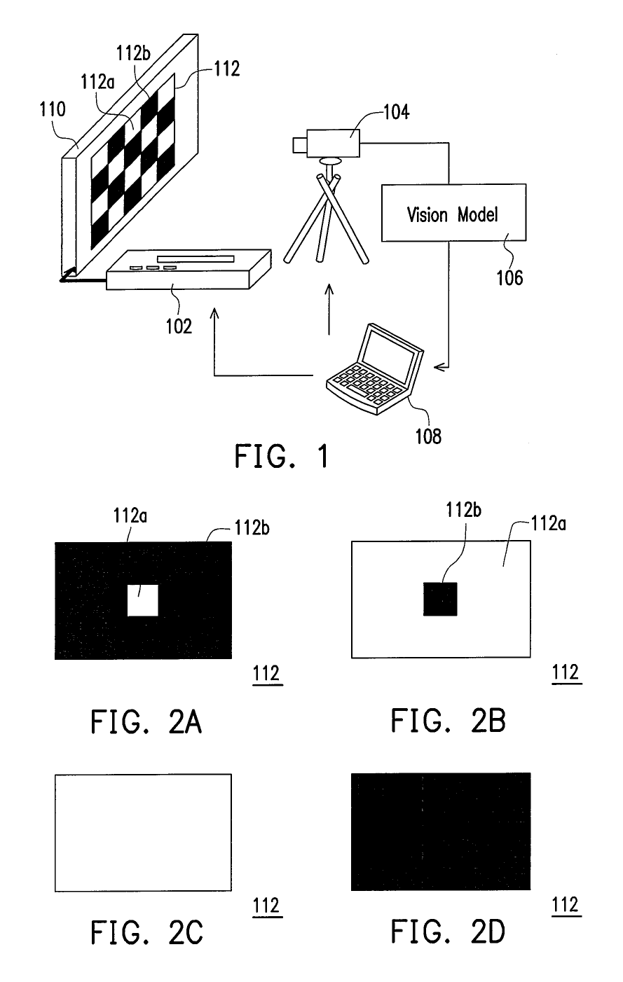

The test frame 112 displayed on the display device 110 is, for example, formed by matching at least one first pattern 112a and at least one second pattern 112b, and the gray level of the first pattern 112a is different from that of the second pattern 112b. Preferably, the gray level of the first pattern 112a is a maximum gray level (for example, 256^{th} level) of the display device, the gray level of the second pattern 112b is a minimum gray level (for example, 1^{st} level) of the display device. In the test frame 112 shown in FIG. 1, the first pattern 112a and the second pattern 112b are distributed in a checkerboard manner, but the present invention is not limited thereby, that is, the test frame displayed on the display device 110 may be other image patterns. For example, as shown in FIG. 2A, the first pattern 112a is located at the center of the test frame 112, and the second pattern 112b surrounds the first pattern 112a. Alternatively, as shown in FIG. 2B, the second pattern 112b is located at the center of the test frame 112, and the first pattern 112a surrounds the second pattern 112b. In another embodiment, the test frame 112 may further have a full frame with a high gray level (for example, full white frame), as shown in FIG. 2C, its gray level (for example, the 256^{th} level) is higher than that of the gray frame at the medium gray level. Alternatively, as shown in FIG. 2D, the test frame 112 may be a full frame with a low gray level and its gray level (for example, 1^{st} level) is lower than that of the gray frame at the medium gray level.

Furthermore, referring to FIG. 1, the image capture device 104 of the detecting apparatus is disposed in front of the display device 110, which is used for capturing the images displayed on the display device 110. Here, the image capture device 104 includes a charge coupled devices (CCD) or complementary metal-oxide-semiconductor (CMOS) device or other image detection devices. The image capture device 104 may further includes lenses, image capturing card and computer.

In addition, as shown in FIG. 1, the vision model 106 is used to convert the image signals captured by the image capture device 104 into human visual perception. Particularly, the vision model 106 quantifies the image signals captured by the image capture device 104, so as to simulate human visual perception when viewing the image. In this embodiment, the vision model 106 may be the one as disclosed in Taiwan Patent Publication No. 1267737, which is incorporated herein as a reference.

Furthermore, in FIG. 1, the controller 108 is electrically connected to the vision model 106, the image capture device 104, and the pattern generator 102. The controller 108 is used for receiving quantification result or simulation result from the vision model 106, and converting the simulation result into image-sticking levels. The controller 108 further controls the pattern generator 102 to generate a specific pattern to the display device 110, so that the display device 110 displays the test frame 112, and it also controls various parameters for displaying the test frame 112 on the display device 110, including time, gray and pattern, etc. The controller 108 may further controls the NO and OFF of the image capture device 104. In this embodiment, the controller 108 is, for example, a computer.

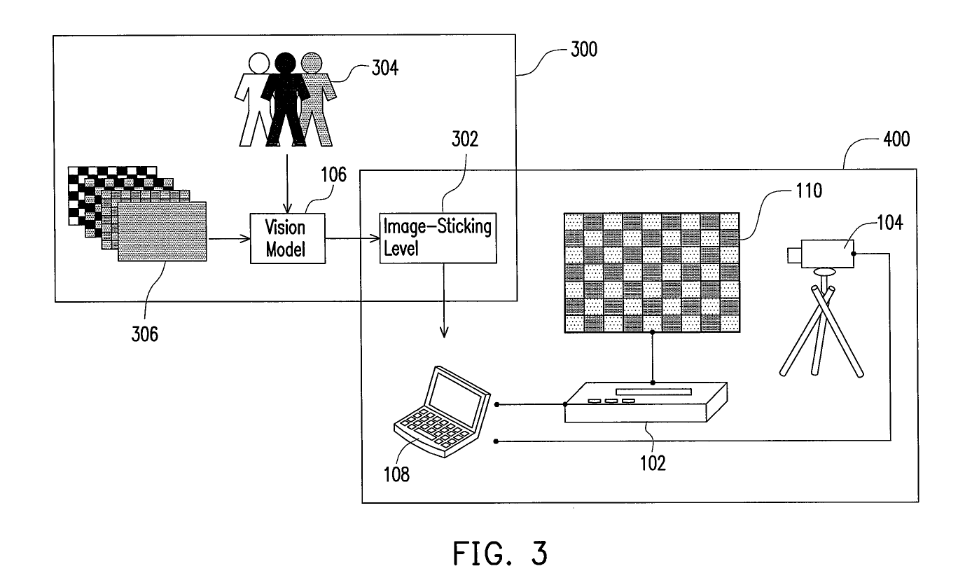

Before using the detecting apparatus to detect the image-sticking defect of the display device as shown in FIG. 1, so-called image-sticking levels are established first. As shown in FIG. 3, before performing a detecting mode 400, a training mode 300 must be performed. The so-called training mode 300 refers to using images at different image-sticking levels to perform ergonomic test to find out threshold values of human eyes towards different image-sticking degrees, so as to serve as indexes for evaluating the image-sticking level, for example, the image-sticking level is graded into Level 1, Level 2 . . . . Here, directed to different types or forms of display devices, the training mode 300 may construct corresponding indexes for evaluating the image-sticking level. More particularly, various image-sticking degrees 306 for each type or form of display device are input into the vision model 106, and then, the human eyes' perceptual factor 304 is also added into the vision model 106, so as to find out the threshold value level index 302 of the sensitivity of human eyes towards different image-sticking phenomena.

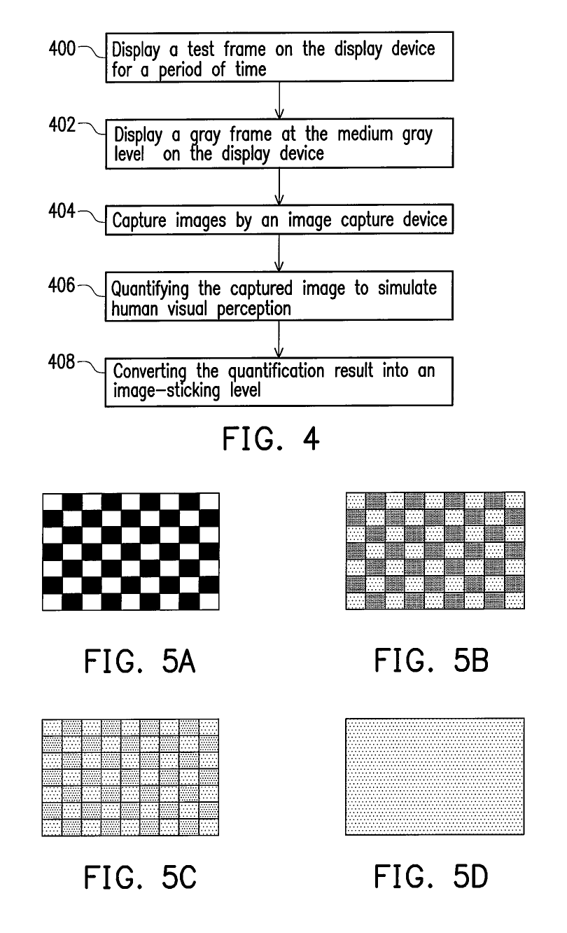

After finishing the above training mode 300, the detecting mode 400 is performed. The method of detecting image-sticking defect of a display device in this embodiment is illustrated below, with reference to the detecting mode shown in FIG. 3, together with the flow chart of the detecting method shown in FIG. 4.

Referring to both FIGS. 3 and 4, firstly, in Step 400, a test frame is displayed on the display device for a period of time, that is, the test frame is used for burn-in. In this step, for example, the computer 108 shown in FIG. 3 is used to control the pattern generator 102 to generate a specific pattern to the display device 110, such that the display device 110 displays a test frame for burn-in. The test frame is, for example, the above-mentioned pattern (e.g., checkerboard form). At this time, the test frame is continuously burnt in on the display device 110 for a period of time, such that the image-sticking defect occurs for the test frame on the display device 110.

Next, in Step 402, a gray frame at a medium gray level is displayed on the display device. In this step, for example, the computer 108 shown in FIG. 3 controls the pattern generator 102 to generate a gray frame at the medium gray level on the display device 100. At this time, since the image-sticking defect occurs on the display device 100 in the Step 400 due to the burn-in of the test frame, when the gray frame at the medium gray level is displayed in Step 402, the pattern of the previous test frame may be viewed in this frame, that is, the so-called image-sticking. The gray level of the gray frame at the medium gray level falls in the middle section for gray levels of the display device 110, for example, if the display device has 256 gray levels, the gray level of the gray frame at the middle section may be any one between the 90^{th} to 130^{th} levels.

Then, in Step 404, the image capture device is used to capture images. In this step, for example, the controller 108 shown in FIG. 3 controls the image capture device 104 to capture the image frame on the display device 110 (i.e., the image when the gray frame at the medium gray level is displayed). The captured image signal is transmitted to the controller 108.

Then, in Step 406, the captured image is quantified to simulate the human visual perception. Then, in Step 408, the quantification results are converted into an image-sticking level. In this step, the image-sticking level 302 obtained in the training mode 300 of FIG. 3 is taken as an index, that is, once the controller 108 quantifies the captured image signal, the quantification result is compared with the image-sticking level 302, so as to determine which image-sticking level the image signal belongs to.

FIGS. 5A to 5D are schematic views of four different image-sticking levels, which are the images when the display device displays the gray frame at the medium gray level, and the test frame before displaying the gray frame at the medium gray level is in checkerboard distribution. FIG. 5A shows the highest image-sticking level, FIG. 5B shows a relatively high image-sticking level, FIG. 5C shows a relatively low image-sticking level and FIG. 5D shows the lowest image-sticking level. In FIGS. 5A to 5C, it can be significantly seen that, there is still a checkerboard pattern of the test frame in the gray frame at the medium gray level, which is caused by the residual image left due to the previous burn-in process of the test frame. Even if it has already switched to the gray frame at the medium gray level, human eyes can also view the pattern of the previous frame (test frame). It cannot find the checkerboard pattern in the frame shown in FIG. 5D, and thus the image-sticking defect is at the lowest level in FIG. 5D.

It should be mentioned that, the test frame and the gray frame at the medium gray level in the above embodiments are illustrated by taking gray image as an example, actually, the method and apparatus of the present invention may also be applied to colored image frames, for example, the image-sticking detection of red images, green images, or blue images, that is to say, the detecting frame and the gray frame at the medium gray level are red images, green images or blue images.

In the detecting apparatus and method in the present invention, the image-sticking defect shown in FIGS. 5A to 5D can be graded automatically, so as to avoid influencing the grading of the image-sticking level due to the personal difference. Furthermore, in the detecting apparatus and method of the present invention, the vision model is added to simulate the human visual perception in viewing image-sticking defect. Therefore, compared with the conventional measuring method through using electronic signals or luminance meter, the method and apparatus of the present invention is more close to the image-sticking defect that is actually observed with human eyes.

Furthermore, since the method and apparatus of the present invention uses an image capture device to capture the whole frame, when the controller is subsequently used for quantification analysis, each part of the whole frame may be analyzed one by one. Besides analyzing the image-sticking level, the method and apparatus of the present invention may further analyze other parameters of the image-sticking, such as position and area of the image-sticking, so as to serve as references of detecting the products and manufacturing process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of detecting image-sticking defect of a display device based on a vision model, comprising:
providing a display device;
displaying a test frame on the display device for burning in;
after burning in the test frame for a period of time, displaying a gray frame at a medium gray level on the display device, wherein a gray level of the gray frame falls between a minimum gray level and a maximum gray level of the display device, and the gray level of the test frame is different from that of the gray frame at the medium gray level;
capturing an image by an image capture device when the display device displays the gray frame at the medium gray level;
using a vision model to quantify an image signal captured by the image capture device, so as to simulate human visual perception when viewing the image; and
converting simulation results into an image-sticking level.

2. The method of detecting image-sticking defect of a display device as claimed in claim 1, wherein the test frame is formed by matching at least one first pattern and at least one second pattern, and the gray level of the first pattern is different from that of the second pattern.

3. The method of detecting image-sticking defect of a display device as claimed in claim 2, wherein the gray level of the first pattern is the maximum gray level of the display device, and the gray level of the second pattern is the minimum gray level of the display device.

4. The method of detecting image-sticking defect of a display device as claimed in claim 2, wherein the first pattern and the second pattern are distributed in a checkerboard manner.

5. The method of detecting image-sticking defect of a display device as claimed in claim 2, wherein one of the first and second patterns is located at a center of the test frame, and the other one surrounds the former one of the first and second patterns.

6. The method of detecting image-sticking defect of a display device as claimed in claim 1, wherein the test frame comprises a full frame with a high gray level higher than that of the gray frame at the medium gray level, or comprises a full frame with a low gray level lower than that of the gray frame at the medium gray level.

7. The method of detecting image-sticking defect of a display device as claimed in claim 1, wherein the step of converting simulation results into an image-sticking level comprises grading the image-sticking according to the sensitivity of human eyes on the image-sticking of the display device.

8. The method of detecting image-sticking defect of a display device as claimed in claim 1, wherein when the test frame is displayed, and after burning in the test frame for a period of time, an image-sticking occurs on the display device, and the image-sticking is displayed on the gray frame at the medium gray level.

9. The method of detecting image-sticking defect of a display device as claimed in claim 1, wherein the test frame and the frame at the medium gray level are gray images or colored images.

10. The method of detecting image-sticking defect of a display device as claimed in claim 9, wherein the colored image comprises a red image, a green image, or a blue image.

11. The method of detecting image-sticking defect of a display device as claimed in claim 1, wherein the display device is a liquid crystal display or a plasma display panel.

12. An apparatus of detecting image-sticking defect of a display device, comprising:
a pattern generator, electrically connected to a display device, for generating a pattern, wherein the pattern is input to the display device, such that the display device displays a test frame;
an image capture device, disposed in front of the display device, for capturing images displayed on the display device;
a vision model, for converting image signals captured by the image capture device into human visual perception; and
a computer, electrically connected to the vision model, the pattern generator, and the image capture device, for receiving results simulated by the vision model, and controlling the pattern generator and the image capture device.

13. The apparatus of detecting image-sticking defect of a display device as claimed in claim 12, wherein the image capture device comprises a charge coupled devices (CCD) or complementary metal-oxide-semiconductor (CMOS) device.

14. The apparatus of detecting image-sticking defect of a display device as claimed in claim 12, wherein the pattern generated by the pattern generator is formed by matching at least one first pattern with at least one second pattern, and a gray level of the first pattern is different from that of the second pattern.

15. The apparatus of detecting image-sticking defect of a display device as claimed in claim 14, wherein the gray level of the first pattern is a maximum gray level of the display device, and the gray level of the second pattern is a minimum gray level of the display device.

16. The apparatus of detecting image-sticking defect of a display device as claimed in claim 14, wherein the first and second patterns are distributed in a checkerboard manner.

17. The apparatus of detecting image-sticking defect of a display device as claimed in claim 14, wherein one of the first and second patterns is located at a center of the test frame, and the other one surrounds the former one of the first and second patterns.

18. The method of detecting image-sticking defect of a display device as claimed in claim 12, wherein the pattern generated by the pattern generator comprises a full frame with a high gray level higher than that of the gray frame at the medium gray level, or comprises a full frame with a low gray level lower than that of the gray frame at the medium gray level.
